(19) United States
(12) Patent Application Publication
(10) Pub. No.: US 2014/0139389 A1
(43) Pub. Date: May 22, 2014

(54) ANTENNA

(71) Applicant: Kresimir Odorcic, Louisville, KY (US)

(72) Inventor: Kresimir Odorcic, Louisville, KY (US)

(21) Appl. No.: 14/016,507

(22) Filed: Sep. 3, 2013

Related U.S. Application Data
(60) Provisional application No. 61/695,796, filed on Aug. 31, 2012.

(51) Int. Cl. H01Q 7/00; H01Q 15/14

(52) U.S. Cl. CPC H01Q 7/00; H01Q 15/14
USPC 343/834; 343/867; 343/843; 29/601

(57) ABSTRACT

An antenna comprising a first dual delta loop element including a first and a second electromagnetic wave (EM) radiating loop element formed along one axis, where the first and second electromagnetic wave loop elements can be implemented in a delta loop configuration, connected in parallel, and fed in phase. A second dual delta loop element can include a third and a fourth EM radiating loop element formed along an orthogonal axis in the same plane as the first loop. The third and fourth EM loop elements can be implemented in a delta loop configuration, connected in parallel, and fed in phase, where the first dual delta loop element and said second dual delta loop element are disposed in the same plane, having superimposed centers of mass, orthogonal to one another, with related symmetry axis being at ninety degree angle with respect to one another.

### CROSS-REFERENCE TO RELATED APPLICATION

This application claims priority to U.S. provisional patent application Ser. No. 61/695,796, having a filing date of Aug. 31, 2012, the disclosure of which is expressly incorporated by reference herein.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon.

### BACKGROUND AND SUMMARY OF THE INVENTION

The present invention relates to an improved antenna design. Antennas used in very high frequency (VHF) or ultra high frequency (UHF) applications experience various difficulties in use in mobile applications. Antennas can be sensitive to movement of a surface that the antenna mounts on. Accordingly, an improved antenna is provided which addresses various disadvantages of existing antenna designs.

For example, satellite communication (SATCOM) antenna designs can incorporate circular polarization, either right hand circular (RHC) or left hand circular (LHC). A SATCOM antenna design can be implemented with two linear elements (half-wave dipoles) placed orthogonally at exactly ninety degrees; where one radiating element (half-wave dipole) is fed with the signal that is ninety degrees out of phase with respect to the other radiating element (half-wave dipole). A resulting electromagnetic (EM) wave being emitted from such antenna has a circular pattern where a resultant EM field vector traces a circular path, completing one full revolution for every period of RF signal.

Existing antenna designs, e.g., SATCOM antenna designs, based on two orthogonal half-wave dipoles, suffer from relatively low gain values directly overhead an antenna such as, for example, SATCOM antennas. This relatively low gain of existing antennas, eg., SATCOM antennas, drops off even further for other angles of incidence (for example: −60, −45, −30 degree angles of incidence). Most of the times SATCOM must be established and maintained from moving vehicles, ships, or aircraft with varying roll, pitch and yaw angles. The angle of incidence from the communication satellite to SATCOM antenna on a particular craft may be varying to some very extreme values. Thus maintaining a reliable SATCOM connection over large angles of incidence with a low gain antenna is a challenge.

Additional features and advantages of the present invention will become apparent to those skilled in the art upon consideration of the following detailed description of illustrative embodiments.

### BRIEF DESCRIPTION OF THE DRAWINGS

The detailed description of the drawings particularly refers to the accompanying figures in which:

FIG. 1 shows an exemplary two dimensional (2D) picture of a SATCOM antenna with two orthogonal dual delta loop elements;

FIG. 2 shows a simulated three dimensional (3D) radiation pattern of the FIG. 1 exemplary SATCOM antenna design based on two orthogonal dual delta loops;

FIG. 3 shows a 2D cross-section view of simulated antenna gain pattern of an exemplary antenna;

FIG. 4 shows a view of an exemplary antenna designed for operational bandwidth (BW) from 450 MHz to 490 MHz;

FIG. 5A shows an antenna range test setup definition of a 3D radiation pattern for RHC polarization;

FIG. 5B shows an antenna range test setup definition of a 3D radiation pattern for LHC polarization;

FIG. 6A shows test results depicting a 3D radiation pattern of one embodiment having a top down view at 450 MHz;

FIG. 6B shows test results depicting cross polarization 3D radiation pattern of one embodiment having a top down view at 450 MHz;

FIG. 7A shows test results depicting a 3D radiation pattern of one embodiment having a side view at 450 MHz;

FIG. 7B shows test results depicting cross polarization 3D radiation pattern of one embodiment having a side view at 450 MHz;

FIG. 8A shows test results displaying another 3D radiation pattern of one embodiment having a top view at 460 MHz;

FIG. 8B shows test results displaying cross polarization 3D radiation pattern of one embodiment having a top view at 460 MHz;

FIG. 9A shows test results displaying another 3D radiation pattern of one embodiment having a side view at 460 MHz;

FIG. 9B shows test results displaying cross polarization 3D radiation pattern of one embodiment having a side view at 460 MHz;

FIG. 10A shows test results visualizing another 3D radiation pattern of one embodiment having a top view at 470 MHz;

FIG. 10B shows test results visualizing cross polarization 3D radiation pattern of one embodiment having a top view at 470 MHz;

FIG. 11A shows test results visualizing another 3D radiation pattern of one embodiment having a side view at 470 MHz;

FIG. 11B shows test results visualizing cross polarization 3D radiation pattern of one embodiment having a side view at 470 MHz;

FIG. 12A shows test results presenting another 3D radiation pattern of one embodiment having a top view at 480 MHz;

FIG. 12B shows test results presenting cross polarization 3D radiation pattern of one embodiment having a top view at 480 MHz;

FIG. 13A shows test results presenting another 3D radiation pattern of one embodiment having a side view at 480 MHz;

FIG. 13B shows test results presenting cross polarization 3D radiation pattern of one embodiment having a side view at 480 MHz;

FIG. 14A shows test results illustrating another 3D radiation pattern of one embodiment having a top view at 490 MHz;

FIG. 14B shows test results illustrating cross polarization 3D radiation pattern of one embodiment having a top view at 490 MHz;

FIG. 15A shows test results illustrating another 3D radiation pattern of one embodiment having a side view at 490 MHz;

FIG. 15B shows test results illustrating cross polarization 3D radiation pattern of one embodiment having a side view at 490 MHz;

FIG. 16 shows relative gain comparison between orthogonal dual delta loop SATCOM antenna and an equivalent orthogonal half wave dipole SATCOM antenna;

FIG. 17 shows simulation results for radiation pattern of an exemplary orthogonal half-wave dipole SATCOM antenna;

FIG. 18 shows a flow chart for an exemplary method of manufacturing a three dimensional antenna system; and

FIG. 19 shows a flow chart for an exemplary method of manufacturing a two dimensional antenna system.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

An embodiment of the invention can be implemented as a spray-on antenna design to create a low profile antenna which can have a coating applied over it to blend the antenna into its surroundings for aesthetics or other functional reasons. Various low profile antenna designs were designed and manufactured by using electrically conductive coatings. During evaluation of such antennas it was determined that particular antennas, such as SATCOM antennas, have some flaws and drawbacks. One of the reasons for relatively low gain in various antenna designs, such as a SATCOM antenna design with orthogonal half-wave dipoles, was the size of the radiating element. The next obstacle became how to extract higher gain while maintaining inconspicuous, low profile design. Replacing a half-wave dipole radiating element with a full wavelength loop-based radiating element was discovered to yield higher gain. Another problem in providing an improved antenna relates to radiating element feed techniques. When a half-wave dipole is replaced with a full wave loop element, element feed point impedance would almost double to approximately 80-100 ohms in a particular embodiment. Due to design and functional requirements, it is important to retain driven element feed point impedance close to 50 ohms in order to continue feeding the element with a standard coaxial cable (with characteristic impedance of 50 ohms). Another design problem that occurred in developing an embodiment of the invention was addressing the question of how to lower feed point impedance and not lose any antenna performance. A solution was developed which included a design that fed two loop elements in parallel. Where two loop elements are fed in parallel, then they are also fed in phase; the net antenna gain of this dual element antenna array will increase, providing an improved antenna performance. This improved design effectively slashed feed point impedance of single loop element by half, so that the design was back at a desired 50 ohm feed point impedance for each driven element. In addition, the improved antenna design increased gain of each of the radiating elements. In one embodiment, it was found desirable to design an exemplary antenna based on a dual loop radiating element embodiment having a total electrical length of two wavelengths.

Another problem in designing an embodiment of the invention can include selection of a loop element. Assuming two radiating elements are placed orthogonally to one another; also assume a need to feed one element with a signal that is 90 degrees out of phase with respect to the other element in order to obtain circular polarization. In order to minimize mutual coupling and interference of two orthogonally placed radiating elements, it is desirable to select a loop element such that there is minimal crisscrossing and overlapping of said orthogonal elements. Quad loop designs are undesirable due to excessive element overlap resulting from dual quad orthogonal implementation. Circular loop designs are also undesirable due to excessive crisscrossing instances as well. After experimentation with various designs and elements, a delta loop design was found to provide surprising benefits as well as providing minimal crisscrossing with only one occurrence close to a dual delta loop feed point.

One goal in antenna design of one embodiment of the invention in this case is to design an antenna shape with a cross-polarization radiation pattern much smaller (with lower gain) as opposed to the shape of intended polarization. Accordingly, a resulting antenna design in accordance with one embodiment of the invention is more suitable (or more capable) of rejecting unwanted signals of opposing polarization, which is a desired trait in antenna design.

An exemplary embodiment was created with two dual delta loops rotated ninety degrees with respect to one another at the dual loop element feed point. This configuration offered another advantage; the radiating elements were not only orthogonal to one another, but they were also translated linearly with respect to the axis of rotation (linear translation from orthogonal point of rotation to the center of mass of each individual delta loop). This radiating element linear translation away from the axis of rotation provides a significant advantage of an embodiment antenna design in accordance with the invention to reject unwanted signals of opposing polarization; that large “null” or low gain area directly overhead for cross-polarized signals is the result of radiating element linear translation away from the radiating element center of rotation. An embodiment in accordance with the invention thus provides higher gain and better rejection of undesired cross-polarized signals; as compared to other antennas such as a standard SATCOM antenna based on half-wave dipoles.

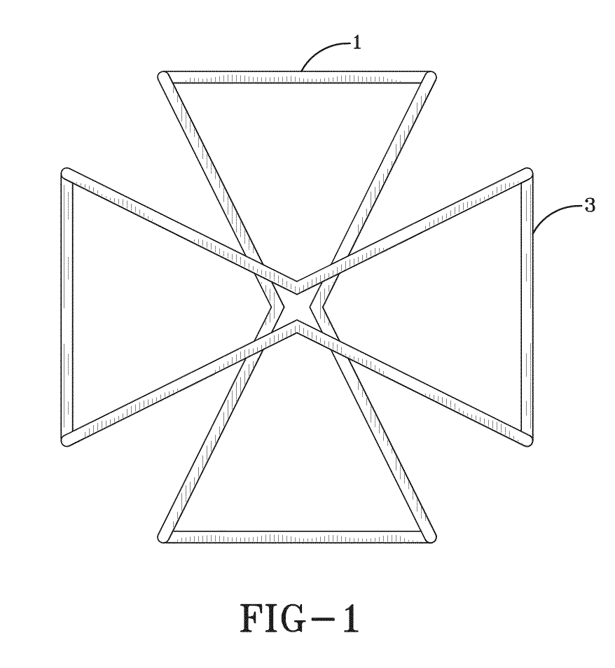

FIG. 1 shows a 2D picture of a SATCOM antenna with two orthogonal dual delta loop elements 1 and 3. The FIG. 1 embodiment can be, for example, an embodiment of the invention that can be created as a part of a spray-on (or conformal) antenna development design. This embodiment can be based on using dual delta loop elements 1 and 3 in an antenna including in SATCOM antennas. Dual delta loop elements 1 and 3 can include essentially two delta loop elements connected in parallel and fed in phase. An embodiment of the invention can include delta loop elements that have an electrical length of one wavelength; consequently an exemplary embodiment including a dual delta loop element has an effective radiating element electrical length of two wavelengths.

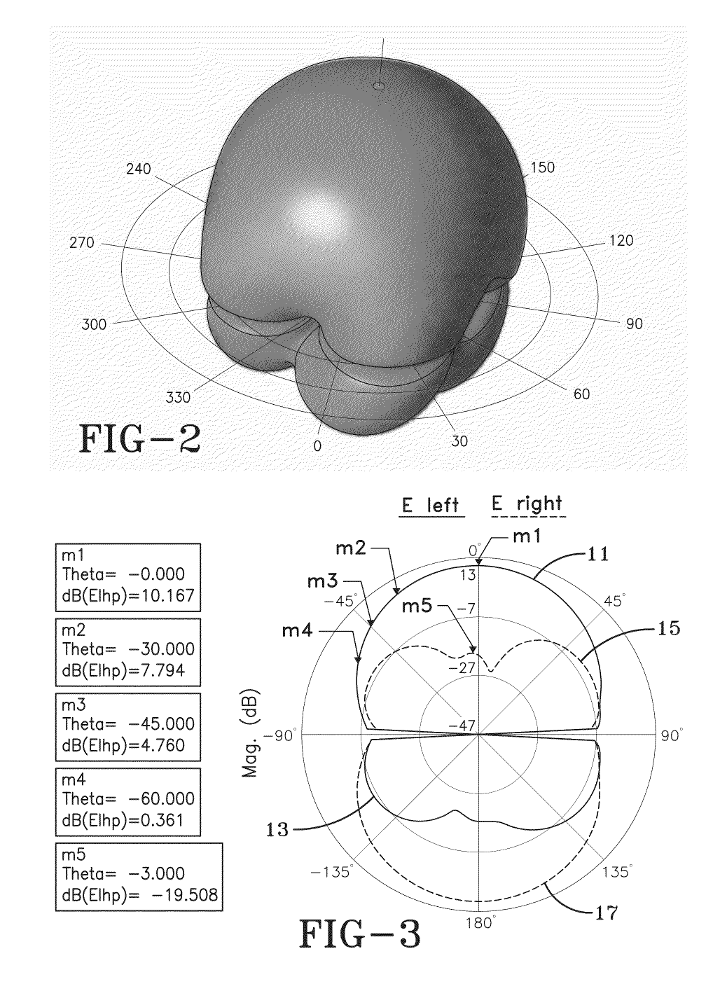

FIG. 2 shows simulated 3D radiation pattern of the FIG. 1 exemplary SATCOM antenna design based on two orthogonal dual delta loops. An antenna designed in accordance with an embodiment of the invention offers significant advantages in all important aspects of antenna performance (e.g., higher gain over its operating bandwidth (BW), wider beam width resulting in higher gain over wider angles of incidence; better cross-polarization isolation resulting in better, more effective rejection of interfering and unwanted signals).

An embodiment of an antenna in accordance with the invention can be constructed by orthogonally placing two dual delta loop elements, and feeding one dual delta loop element with a signal that is ninety degrees out of phase with respect to the other dual delta loop element. As a result, the EM wave radiating from such antenna will also have a circular pattern, where the resultant EM field vector traces a circular path completing one full revolution for every period of radio frequency (RF) signal.

FIG. 3 shows a 2D cross-section view of simulated antenna gain pattern. The top outer trace 11 and bottom inner trace 13 denote values of gain with respect to desired polarization (RHC in this case); the top inner trace 15 and bottom outer trace 17 denote the values of gain with respect to cross-polarization (LHC in this case). The markers (m1, m2, m3, m4) were placed at various angles of incidence; corresponding gains (in dB) at those particular angles of incidence are given on the left hand side of the figure. A marker (m5) was placed at the cross-polarization gain plot to gain an insight in the amount of cross-polarization isolation offered by the proposed antenna design.

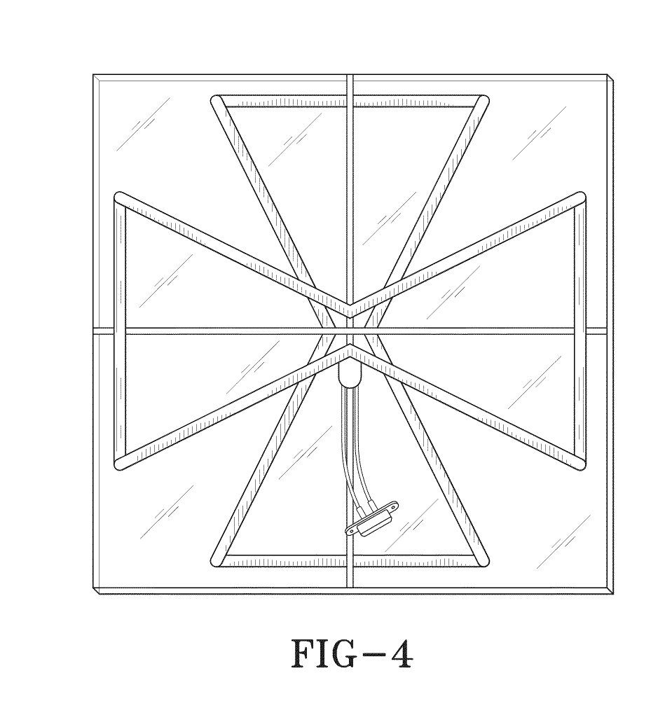

FIG. 4 shows a picture of an exemplary antenna designed for operational BW from 450 MHz to 490 MHz. An embodiment of an exemplary antenna design can be implemented using copper foil tape on a plexiglas surface.

Embodiments of the above referenced invention offer various advantages for antenna designs including circularly polarized SATCOM antennas. Dual delta loop SATCOM antenna design in accordance with the invention offers significantly higher gain (in dB) directly overhead (at 0 degree angle of incidence, see e.g., FIG. 3) as compared to existing SATCOM antenna designs based on half-wave dipoles. This advantage stems from the fact that each dual delta loop radiating element has effective electrical length of two wavelengths, thus offering much higher gain as compared to half-wave dipole, whose electrical length is only one-half wavelengths.

An embodiment of a dual delta loop SATCOM antenna design in accordance with the invention offers significantly higher gains (in dB) at other angles of incidence (simulated −30,−45, −60 degree angles of incidence, e.g., see FIG. 3) as compared to embodiments of SATCOM antenna designs such as ones based on half-wave dipoles. This is advantageous when SATCOM needs to be established and maintained from moving vehicles, ships, and aircraft with varying roll, pitch, and yaw angles.

A peak cross-polarization isolation of an exemplary dual delta loop SATCOM antenna is much higher (approximately −30 dB) as compared to existing SATCOM designs (approximately −20 dB). This parameter is critical in being able to resist interference from other unwanted RF sources and reject unwanted signals. A feed point impedance of an exemplary dual delta loop element remains at 50 ohms, which enables the exemplary SATCOM antenna to be fed directly with any standard 50 ohm coaxial cable, without any need for matching networks or transformers. Introduction of matching networks and transformers is undesirable, since they introduce additional signal loss and reduce antenna efficiency.

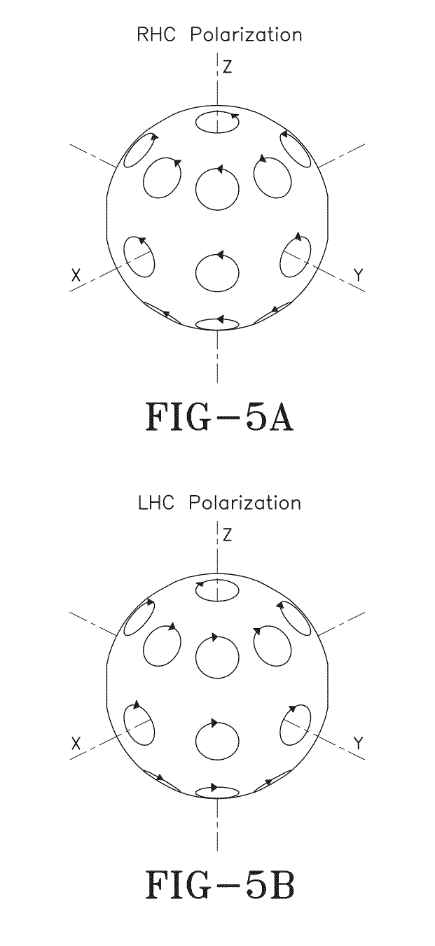

Various embodiments of the invention have been tested at different frequencies listed (or denoted) in FIGS. 5A through 15B which include sets of a 3D radiation pattern plots showing an intended polarization and a cross polarization intended to be compared to each other side by side; e.g., FIG. 5A (intended polarization) and 5B (cross polarization). An exemplary antenna, such as discussed above, can be designed to cover a BW of 450 MHz to 490 MHz. Thus the radiation plots shown in FIGS. 5A to 15B display test results for an exemplary antenna, e.g., discussed above, with an exemplary operational BW in 10 MHz steps. As discussed above and below, there are two sets of plots (showing top down view and side view) at each of the test frequencies that look very different from one another. The sets of plots that look like a “mushroom cap” denote a radiation pattern for dominant (RHC) polarization for said antenna. The other plots are much smaller, complex in shape, with a different signal intensity (yellowish green in a color plot) are plots for opposing, or cross-polarization for an exemplary antenna (in this case LHC).

The radiation plot figures with suffix “A”, from 6A to 15A, include a showing of dominant polarization plots that are uniform in shape with a relatively uniform signal intensity or relative gain distribution across much of the resulting radiation pattern. If the plots in question (e.g., Figs. with suffix “A” from 6A to 15A) were rendered in color, these plots would show a pattern that was mostly red or orange in color denoting uniform radiation field and relatively high gain for intended polarization. Figs. with suffix “B”, from 6B to 15B, show that related cross-polarization plots are enclosing a smaller volume, are not uniform in shape, and are of a different grayscale color (if not in grayscale, these radiation plot figures with suffix “B”, from 6B to 15B, would show yellowish, green, blue colors) denoting much lower gain. These radiation plots with suffix “B”, from 6B to 15B, show that an embodiment of the invention provides a desired capability of effectively rejecting unwanted signals of opposing, or cross-polarization.

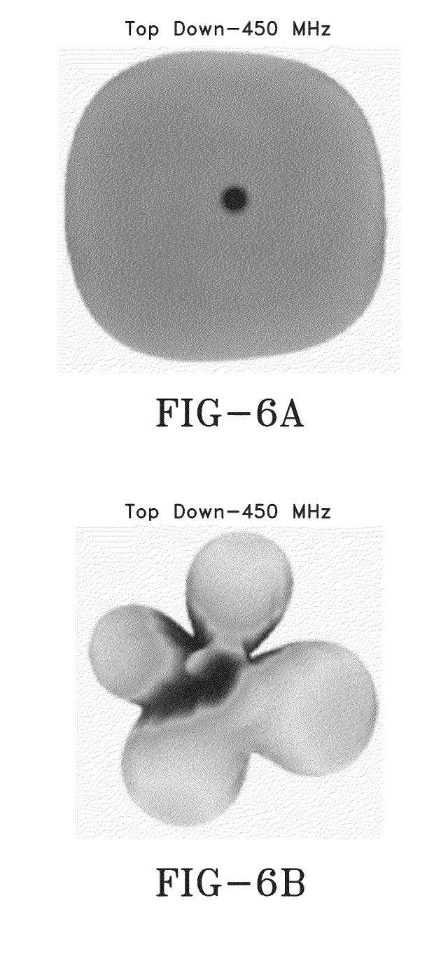

FIGS. 6B, 8B, 10B, 12B, and 14B show a large “null” (area of very low gain) directly overhead for all cross-polarization plots. FIGS. 6B, 8B, 10B, 12B, and 14B show that an exemplary design provides desirable unwanted signal rejection where such signal rejection is most important: directly overhead in an antenna radiation pattern, where an overall signal strengths and potential for unwanted interference is the largest and most likely during SATCOM events.

Radiation plots shown in FIGS. 5A-15B show exemplary antenna functionality at 450, 460, 470, 480, and 490 MHz. These plots show that an exemplary antenna in accordance with one embodiment of the invention maintains its intended gain and performance over its designed bandwidth (refer to top-down and side view radiation plots for dominant or RHC polarization); while it also maintains its ability to effectively reject unwanted signals (refer to top-down and side view radiation plots for cross-polarization or LHC polarization).

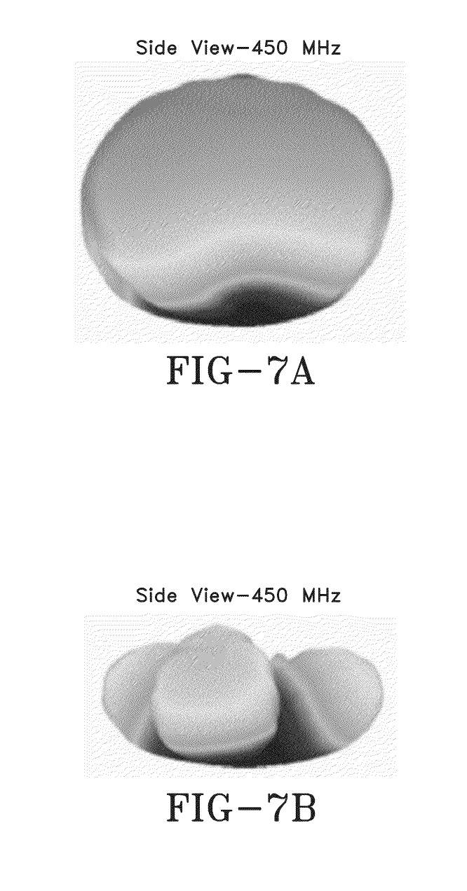

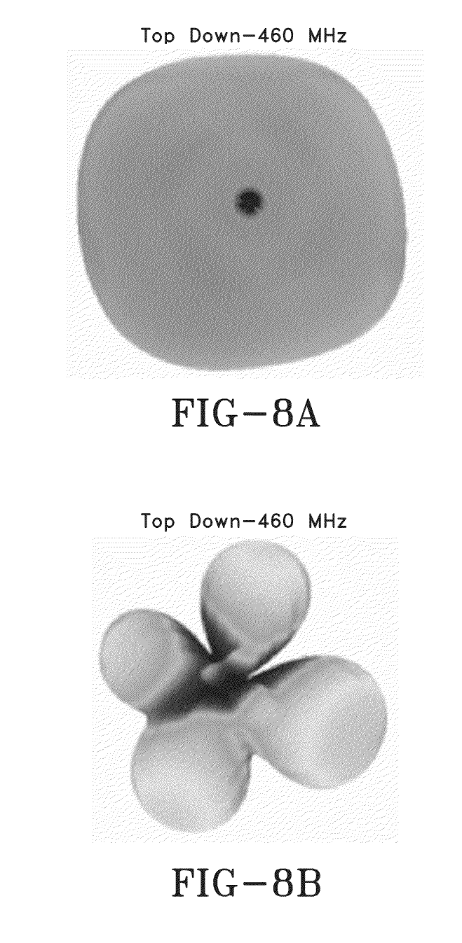

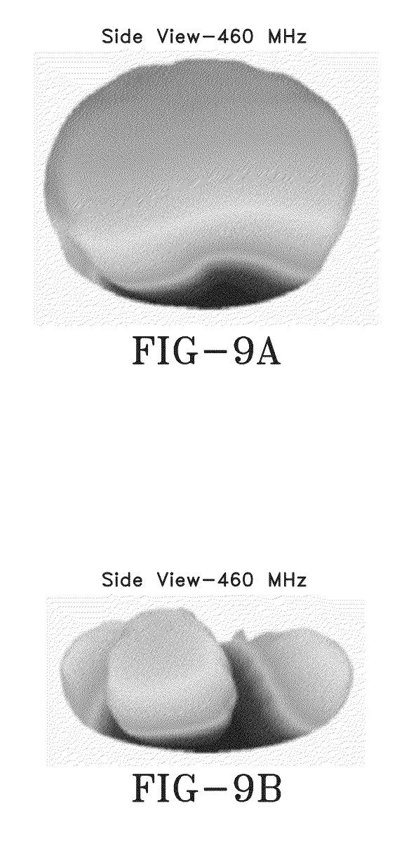

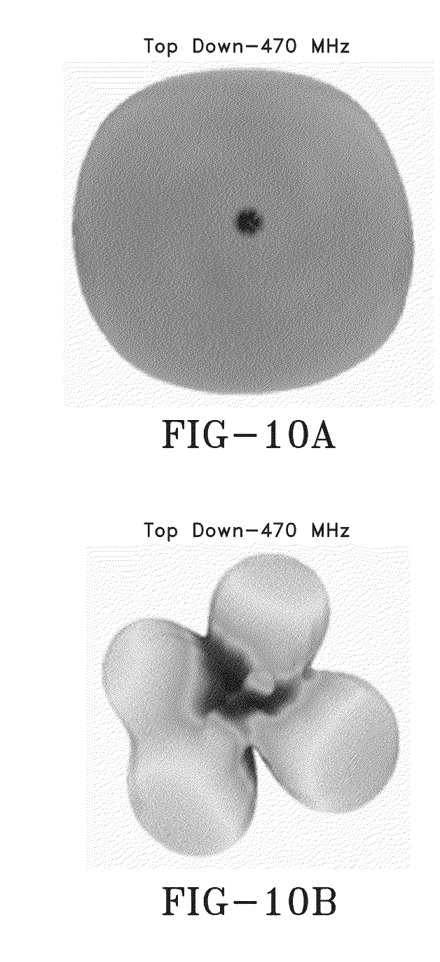

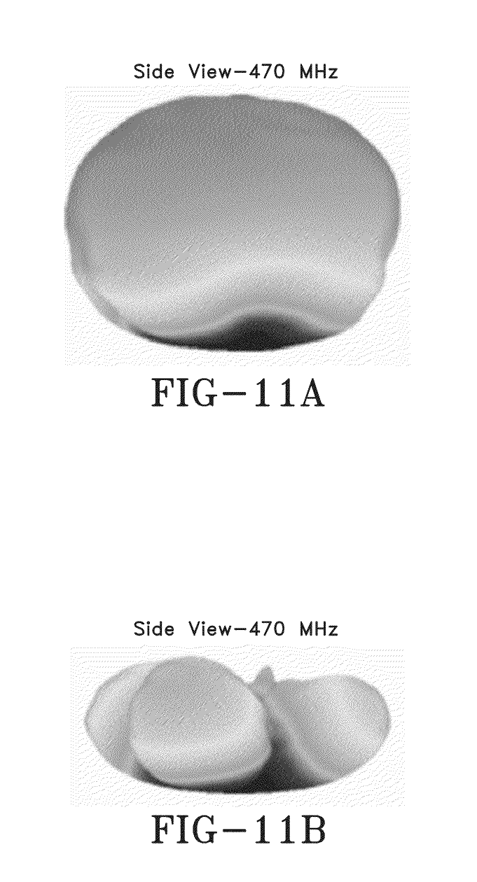

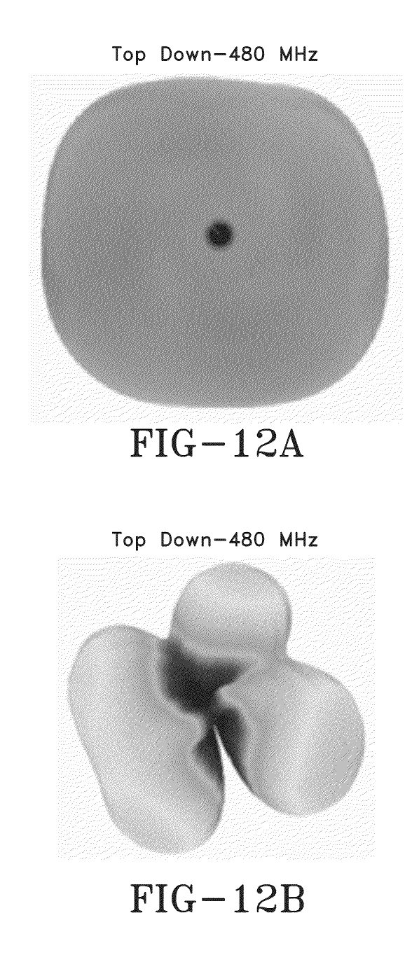

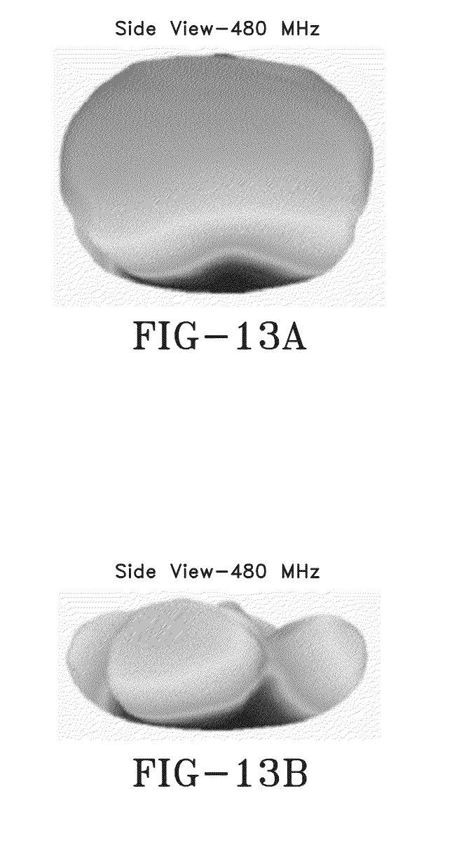

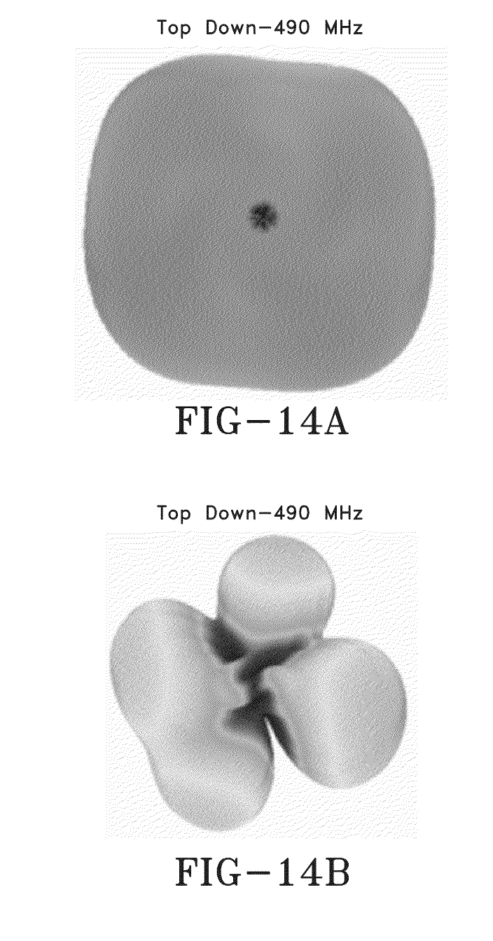

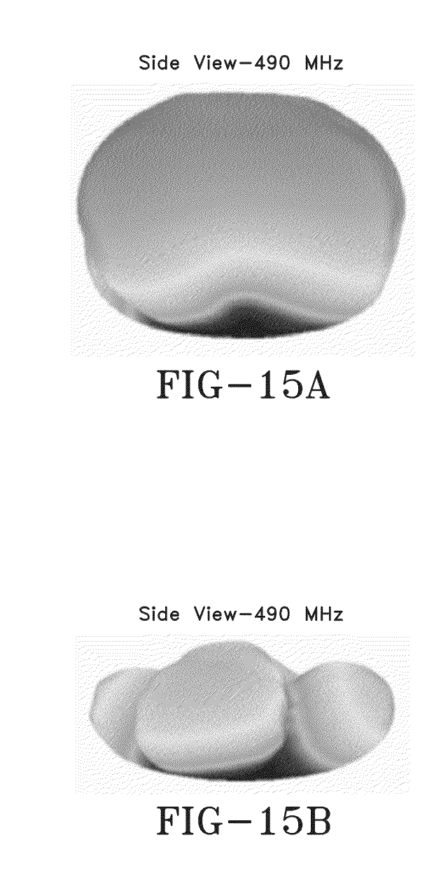

FIG. 5A shows antenna range test setup definition of a 3D radiation pattern for RHC polarization. FIG. 5B shows antenna range test setup definition of a 3D radiation pattern for LHC polarization. FIG. 6A shows test results depicting a 3D radiation pattern of one embodiment having a top down view at 450 MHz. FIG. 6B shows test results depicting cross polarization 3D radiation pattern of one embodiment having a top down view at 450 MHz. FIG. 7A shows test results depicting a 3D radiation pattern of one embodiment having a side view at 450 MHz. FIG. 7B shows test results depicting cross polarization 3D radiation pattern of one embodiment having a side view at 450 MHz. FIG. 8A shows test results displaying another 3D radiation pattern of one embodiment having a top view at 460 MHz. FIG. 8B shows test results displaying cross polarization 3D radiation pattern of one embodiment having a top view at 460 MHz. FIG. 9A shows test results displaying another 3D radiation pattern of one embodiment having a side view at 460 MHz. FIG. 9B shows test results displaying cross polarization 3D radiation pattern of one embodiment having a side view at 460 MHz. FIG. 10A shows test results visualizing another 3D radiation pattern of one embodiment having a top view at 470 MHz. FIG. 10B shows test results visualizing cross polarization 3D radiation pattern of one embodiment having a top view at 470 MHz. FIG. 11A shows test results visualizing another 3D radiation pattern of one embodiment having a side view at 470 MHz. FIG. 11B shows test results visualizing cross polarization 3D radiation pattern of one embodiment having a side view at 470 MHz. FIG. 12A shows test results presenting another 3D radiation pattern of one embodiment having a top view at 480 MHz. FIG. 12B shows test results presenting cross polarization 3D radiation pattern of one embodiment having a top view at 480 MHz. FIG. 13A shows test results presenting another 3D radiation pattern of one embodiment having a side view at 480 MHz. FIG. 13B shows test results presenting cross polarization 3D radiation pattern of one embodiment having a side view at 480 MHz. FIG. 14A shows test results illustrating another 3D radiation pattern of one embodiment having a top view at 490 MHz. FIG. 14B shows test results illustrating cross polarization 3D radiation pattern of one embodiment having a top view at 490 MHz. FIG. 15A shows test results illustrating another 3D radiation pattern of one embodiment having a side view at 490 MHz. FIG. 15B shows test results illustrating cross polarization 3D radiation pattern of one embodiment having a side view at 490 MHz.

FIG. 16 shows relative gain comparison between orthogonal dual delta loop SATCOM antenna and an equivalent orthogonal half wave dipole SATCOM antenna. Exemplary antennas, such as discussed above, were designed with the same operating BW, and were manufactured using similar implementation methods and techniques (e.g., copper foil tracks of equal width and thickness applied on equally thick plexiglas surfaces). Resulting gain values directly overhead dipole and dual loop exemplary SATCOM antennas were measured in a near field using an RF probe and a network analyzer. As can be seen from the plots, an exemplary orthogonal dual delta loop configuration yields consistently higher gain as compared to an equivalent orthogonal half wave dipole SATCOM antenna.

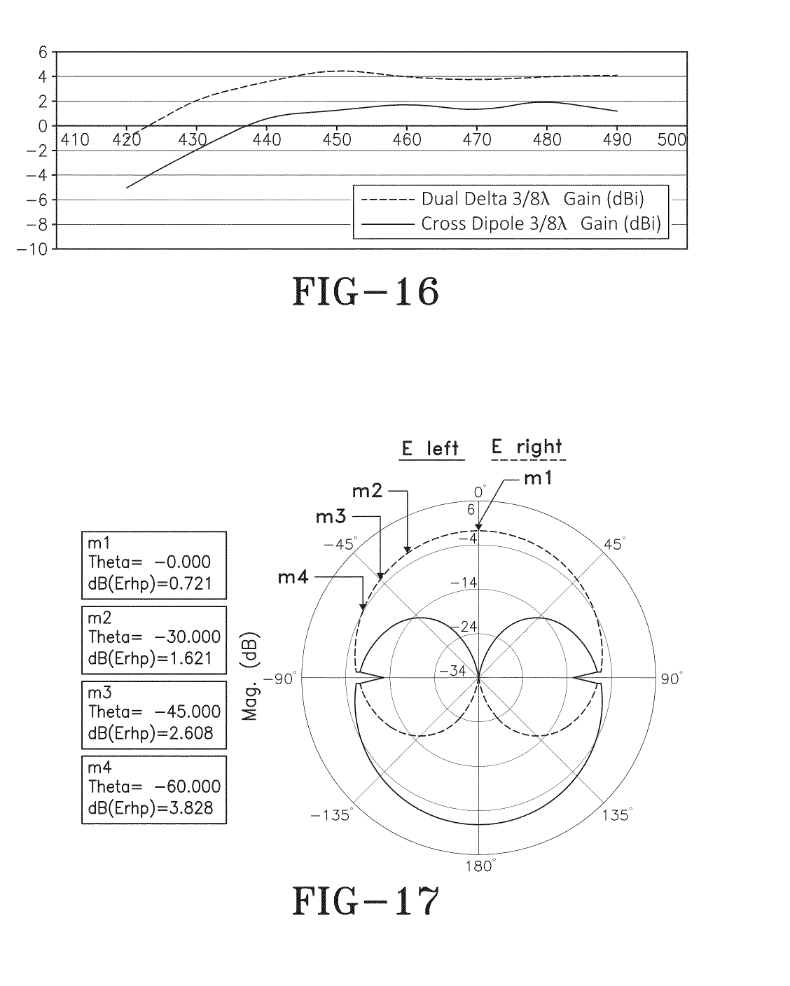

FIG. 17 shows simulation results for radiation pattern of orthogonal half wave dipole SATCOM antenna. This cross sectional plot for the dipole antenna can be compared to FIG. 3 showing simulation results for radiation pattern of orthogonal dual delta loop SATCOM antenna in accordance with one embodiment of the invention. FIG. 17 and FIG. 3 shows E field values displayed on left hand sides of each respective figures. FIGS. 17 and 3 show gain values (in dB) at −30 deg, −45 deg, and −60 deg angles of incidence that are larger for an exemplary orthogonal dual delta loop SATCOM antenna as compared to an orthogonal half wave dipole SATCOM antenna.

Embodiments of the invention can be implemented with standard metal antenna construction using conductive metal rods made from, for example, copper or aluminum. In addition, this design can be implemented using spray-on (or conformal coating) antenna technology resulting in relatively low profile, inconspicuous design. If the surface of such spray-on antenna is painted over with a non-metallic paint matching the color of the surrounding antenna surface, the net result is completely invisible antenna design.

One exemplary embodiment of an antenna design in accordance with the invention can be placed at a distance equivalent to ⅜ wavelength away from a RF reflective surface (whether being vehicle chassis, craft chassis, or ground). This placement ensures maximum gain over maximum beam width for an intended radiation pattern (e.g., resulting in optimum (or so called “mushroom cap”) radiation pattern). If an antenna is placed below ⅜ wavelength distance away from an RF reflective surface, an antenna's gain directly overhead will increase; however a resulting radiation beam width will be reduced resulting in overall gain decrease for other angles of incidence. If an exemplary antenna is placed above ⅜ wavelength distance away from a RF reflective surface, then large “nulls” (areas of very low gain) will start appearing in dominant or intended radiation pattern plots.

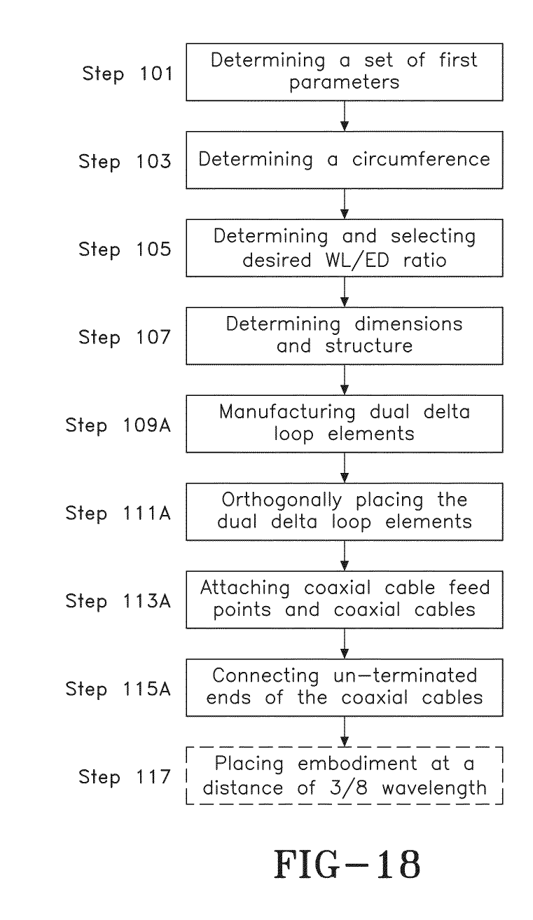

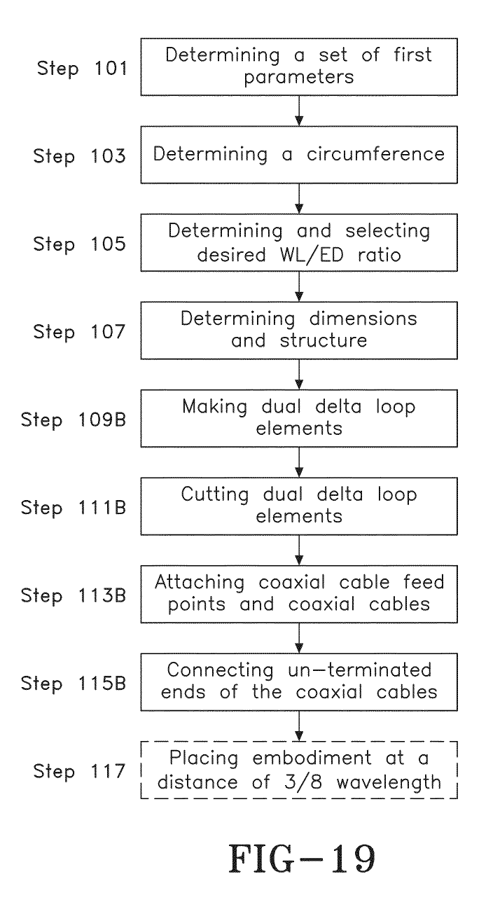

Processes and methods for manufacturing an antenna in accordance with embodiments of the invention will now be discussed. FIGS. 18 and 19 show exemplary methods of manufacturing an antenna system. FIG. 18 shows a method for 3D implementation, and FIG. 19 shows a method for 2D implementation.

Step 101 includes a determination of an operating BW, center frequency of the operating BW, and amount of RF power that needs to be transmitted. In most instances for VHF and UHF antenna designs, a size of a radiating element profile chosen (the size of the cross sectional area and the surface area) should be adequate to handle any reasonable amount of RF power being transmitted (e.g., <500 W). At the end of each design procedure, it is desirable to verify the power handling capacity of designed antenna to ensure adequate cross sectional and surface area was provided by radiating elements for efficient RF emissions from said antenna design.

In particular, a set of parameters, such as described above, should be specified for a desired antenna e.g., an VHF/UHF antenna design (at a minimum) to include: lowest operating frequency (in MHz) of AA; center operating frequency (in MHz) of BB; highest operating frequency (in MHz) of CC. Center operating frequency parameter (in MHz) is used to define the midpoint-to-midpoint length of the radiating element.

Step 103 includes determining a circumference of an exemplary dual delta loop element based on step 101 information. Recall that the radiating element in this particular design is a dual delta loop having a total electrical length of two wavelengths (lambda). Equation 1 defines an overall circumference of an exemplary dual delta loop element (assuming the ratio of wavelength to element diameter is relatively large) as follows where 24120 is a selected exemplary size value:

Equation 1

Circumference_dual_delta_loop_element (inches)=24120 (inch*MHz)/BB (MHz)

For an exemplary fixed circumference loop element, increasing element diameter (or element cross sectional area) has an effect of increasing a resonant frequency of the above referenced fixed circumference loop element. To compensate for this unwanted resonant frequency shift, the circumference of a given radiating loop element needs to be increased accordingly if original (or intended) resonant frequency is to be retained.

Step 105 includes determining and selecting desired wavelength to element diameter (WL/ED) ratio based on step 101 and 103 information. A ratio of WL/ED can rarely be assumed to be large due to relatively large element diameters (or element cross sectional areas) used in VHF and UHF antenna realizations and implementations. For these instances of non-ideal WL/ED ratio, Equation 1 should be modified to account for various WL/ED values in order to retain expected and desired resonant frequency of given radiating loop elements. For example, if WL/ED ratio is 160, the element circumference needs to increase by approximately 2%. Consequently, Equation 1 for circumference of dual delta loop element becomes:

Equation 2

Circumference_dual_delta_loop_element (inches)=24602 (inch*MHz)/BB (MHz)

Equation 2 is an exemplary value that is only valid for WL/ED ratio approximately equal to 160.

In another instance, if WL/ED ratio is 80, the element circumference will be increased by approximately 5%. Consequently, Equation 2 for circumference of dual delta loop element becomes:

Equation 3

Circumference_dual_delta_loop_element (inches)=25326 (inch*MHz)/BB (MHz)

Equation 3 is only valid for WL/ED ratio approximately equal to 80

An exemplary design will thus be based on antenna radiation plots and curves showing relationships between various WL/ED ratios and resulting circumference elongation factors that need to be applied for particular radiating loop element design.

WL/ED ratio parameter value selection also affects desired BW for given radiating loop element. For two fixed circumference loop elements, the element with a larger WL/ED ratio shall have narrower operating BW while the element with smaller WL/ED ratio shall have wider operating BW. Antenna curves or loop antenna curves showing the relationship of WL/ED ratio and resulting BW for given loop element center frequency can also be used to determine design parameters for an exemplary embodiment.

The process for calculating the circumference of dual delta loop element and selecting desired WL/ED ratio is somewhat iterative and may need to be repeated several times until the value of circumference and WL/ED ratio are found that satisfy desired parametric criteria.

Step 107 includes determining dimensions and structure of the dual delta loop antenna element. Given the fact that dual delta loop element consists essentially of two equilateral triangles, the dimension of each triangle side (or delta loop edge) is obtained by dividing the overall dual delta loop circumference by six as shown in Equation 4.

Equation 4

Length_dual_delta_loop_edge (in inches)=Circumference_dual_delta_loop_element (in inches)/6 (unitless constant)

An exemplary manufacturing process at this point diverges into two separate paths; depending if traditional 3D implementation is desired, or low profile, inconspicuous, 2D is pursued. If 3D implementation is desired, then:

Step 109A: Manufacturing dual delta loop elements from available conductive metal profile bars, rods or tubes based on information from steps 101 to 107. The bars, rods or tubes can be shaped into dual delta loop elements using bending machines; alternatively a desired shape of dual delta loop elements can be created from cast structures as well.

Step 111A: Orthogonally placing the dual delta loop elements with respect to one another and affixing them to maintain such orthogonal position and orientation using electrically non-conductive fixtures, spacers, or braces.

Step 113A: Attaching coaxial cable feed points and coaxial cables to each dual delta loop element (located approximately at the center of mass for each dual delta loop element). Coaxial cables can be precisely of equal length in order to avoid introduction of additional phase shift in emitted radiation from the exemplary antenna due to unequal coaxial cable lengths.

Step 115A: Connecting un-terminated ends of the coaxial cables to an in-phase-terminal and to a ninety degrees-out-of-phase-terminal of a hybrid coupler, respectively. It is the function of the hybrid coupler to introduce desired 90 degree phase shift needed for proper operation of this circularly polarized antenna. The remaining common terminal of a hybrid coupler is to be connected to antenna terminal of a given SATCOM transceiver to enable desired SATCOM.

If 2D implementation is desired:

Step 109B: Making dual delta loop element shapes on a desired surface where conductive metal foil or conductive spray coating is to be applied based on steps 101-107. Note that due to crisscrossing of the elements, each dual delta loop element needs to be masked on a different side of a relatively thin wall non-conductive surface (i.e. panel, skin, or window on a vehicle or a craft made from glass, carbon fiber, fiberglass, plexiglas, etc.).

Step 111B: Cutting dual delta loop elements out from metallic foil and affixing to a desired location on a non-conductive surface; alternatively dual delta loop elements can be sprayed on directly on previously masked non-conductive surface.

Step 113B: Attaching coaxial cable feed points and coaxial cables to each dual delta loop element (located approximately at the center of mass for each dual delta loop element). Coaxial cables need to be precisely of equal length in order not to introduce additional phase shift due to unequal coaxial cable lengths.

Step 115B: Connecting un-terminated ends of said coaxial cables to an in-phase-terminal and to a ninety-degree-out-of-phase-terminal of a hybrid coupler, respectively. It is the function of the hybrid coupler to introduce desired ninety degree phase shift needed for proper operation of this circularly polarized antenna. The remaining common terminal of a hybrid coupler is to be connected to antenna terminal of a given SATCOM transceiver to enable desired SATCOM.

Optional step 117 includes placing an embodiment of the invention at ⅜ wavelength away from the radiating elements if application and implementation of a RF reflective plane is desired and feasible in a particular embodiment. The ⅜ wavelength distance is calculated for the highest frequency of operation for particular antenna design in order to avoid the “nulls” in antenna radiation pattern over said antenna operating BW. The equation for the separation distance between the RF reflective plane and the radiating elements is shown in Equation 5:

Equation 5

Distance_RF_plane_to_radiating_element (inches)=4429.13 (inch*MHz)/CC (MHz)

Although the invention has been described in detail with reference to certain preferred embodiments, variations and modifications exist within the spirit and scope of the invention as described and defined in the following claims.

1. An antenna system comprising:
a first dual delta loop element comprising a first and a second electromagnetic wave radiating loop element formed along one axis; said first and second electromagnetic wave radiating loop elements being implemented in a delta loop configuration, connected in parallel, and fed in phase; and
a second dual delta loop element comprising a third and a fourth electromagnetic wave radiating loop element formed along an orthogonal axis of the same plane; said third and fourth electromagnetic wave radiating loop elements being implemented in a delta loop configuration, connected in parallel, and fed in phase;
wherein said first dual delta loop element and said second dual delta loop element laying in the same plane, having superimposed centers of mass, orthogonal to one another with related symmetry axes being at a ninety degree angle with respect to one another;
wherein said antenna system is adapted to feed said first dual delta loop element with a signal that is ninety degrees out of phase with respect to said second dual delta loop element;
wherein said antenna system is adapted so that an electromagnetic wave radiating from said first and second dual delta loop elements will also have a circular pattern, where the resultant electromagnetic field vector traces a circular path completing one full revolution for every period of electromagnetic signal emitted.

2. An antenna system as in claim 1, wherein said electromagnetic signal comprises a radio frequency signal.

3. An antenna system as in claim 1, wherein said delta loop elements have an electrical length of one wavelength.

4. An antenna system as in claim 1, wherein said dual delta loop elements have an effective radiating element electrical length of two wavelengths.

5. An antenna system as in claim 1, wherein said orthogonal dual delta loop elements comprise a spray-on or conformal antenna structure.

6. An antenna system as in claim 1, wherein said orthogonal dual delta loop elements are formed using a conductive foil tape.

7. An antenna system as in claim 1, wherein said conductive foil tape comprises copper foil.

8. An antenna system as in claim 1, wherein said orthogonal dual delta loop elements are formed on a non-conductive surface.

9. An antenna system as in claim 8, wherein said non-conductive surface comprises a plexiglas surface.

10. An antenna system as in claim 1, wherein said dual delta loop structure is adapted to have a peak cross polarization isolation of approximately −30 dB and a feed point impedance of approximately 50 ohms.

11. An antenna system as in claim 1, wherein said dual delta loop structure is mounted with a predetermined distance and orientation with respect to an adjacent RF reflective surface to produce maximum gain over maximum beam width for an intended radiation pattern.

12. An antenna system as in claim 11, wherein said mounting of said dual delta loop structure comprises placing said dual delta loop structure at a distance equivalent to approximately ⅜ wavelength away from a RF reflective surface.

13. An antenna system as in claim 1, wherein each said dual delta loop element is masked on a different side of a relatively thin non-conductive structure.

14. An antenna system comprising:
a first dual delta loop element comprising a first and a second electromagnetic wave radiating loop element formed along one axis; said first and second electromagnetic wave radiating loop elements being implemented in a delta loop configuration, connected in parallel, and fed in phase; and
a second dual delta loop element comprising a third and a fourth electromagnetic wave radiating loop element formed along an orthogonal axis of the same plane; said third and fourth electromagnetic wave radiating loop elements being implemented in a delta loop configuration, connected in parallel, and fed in phase;
wherein said first dual delta loop element and said second dual delta loop element laying in the same plane, having superimposed centers of mass, orthogonal to one another with related symmetry axes being at a ninety degree angle with respect to one another;
wherein said antenna system is adapted to feed said first dual delta loop element with a signal that is ninety degrees out of phase with respect to said second dual delta loop element;
wherein said antenna system is adapted so that an electromagnetic wave radiating from said first and second dual delta loop elements will also have a circular pattern, where the resultant electromagnetic field vector traces a circular path completing one full revolution for every period of electromagnetic signal emitted;
wherein said orthogonal dual delta loop elements comprise a planar or conformal antenna form;
wherein said orthogonal dual delta loop elements are formed on a non-conductive surface;
wherein said dual delta loop structure is mounted with a predetermined distance and orientation with respect to an adjacent RF reflective surface to produce maximum gain over maximum beam width for an intended radiation pattern;
wherein each said dual delta loop element is masked on a different side of a relatively thin non-conductive structure.

15. An antenna system as in claim 14, wherein said electromagnetic signal comprises a radio frequency signal.

16. An antenna system as in claim 14, wherein said delta loop elements have an electrical length of one wavelength.

17. An antenna system as in claim 14, wherein said dual delta loop elements have an effective radiating element electrical length of two wavelengths.

18. An antenna system as in claim 14, wherein said orthogonal dual delta loop elements comprise a spray-on or conformal antenna structure.

19. An antenna system as in claim 14, wherein said orthogonal dual delta loop elements are formed using a conductive foil tape.

20. An antenna system as in claim 19, wherein said conductive foil tape comprises copper foil.

21. An antenna system as in claim 14, wherein said non-conductive surface comprises a plexiglas surface.

22. An antenna system as in claim 14, wherein said dual delta loop structure is adapted to have a peak cross polarization isolation of approximately −30 dB and a feed point impedance of approximately 50 ohms.

23. An antenna system as in claim 14, wherein said mounting of said dual delta loop structure comprises placing said dual delta loop structure at a distance equivalent to approximately ⅜ wavelength away from a RF reflective surface.

24. A method of manufacturing an antenna system comprising: determining a set of first parameters comprising operating band width (BW), a lowest operating frequency denoted by AA, a center frequency of the operating BW denoted by BB, a highest operating frequency denoted by CC, a midpoint-to-midpoint length of the radiating element based on BB, and an electromagnetic wave power transmission value for the antenna system;
determining a circumference of a first and second dual delta loop electromagnetic radiating element based on said set of first parameters assuming the ratio of wavelength to element diameter is relatively large wherein said circumference is increased as an element disaster or element cross sectional area is increased to avoid increasing a resonant frequency shift of said first and second dual delta loop electromagnetic radiating elements to retain a predetermined resonant frequency;
determining and selecting desired wavelength to element diameter (WL/ED) ratio based on said set of first parameters and said circumference of said first and second dual delta loop electromagnetic radiating elements, wherein said element circumference are adjusted to retain said predetermined resonant frequency of said first and second dual delta loop electromagnetic radiating elements as said WL/ED ratio changes;
determining dimensions and structure of the dual delta loop antenna elements based on dividing an overall dual delta loop antenna structure circumference by six, wherein said overall dual delta loop antenna structure circumference is determined based on said WL/ED, said set of first parameters, and said circumference of said first and second dual delta loop electromagnetic radiating elements;
forming said dual delta loop elements;
attaching coaxial cable feed points and coaxial cables to each said dual delta loop element located approximately at a center of mass for each said dual delta loop element; and
connecting un-terminated ends of said coaxial cables to an in-phase-terminal and to a ninety-degree-out-of-phase-terminal of a hybrid coupler, respectively.

25. A method as in claim 24, further comprising coupling a common terminal of the hybrid coupler to an antenna terminal of a transceiver.

26. A method as in claim 24, further comprising forming an RF reflective plane by placing said dual delta loop elements at ⅜ wavelength away from the dual delta loop elements.

27. A method as in claim 26, wherein the ⅜ wavelength distance is calculated for the highest frequency of operation for a particular antenna design denoted by said CC in order to avoid nulls in an antenna radiation pattern produced by said dual delta loop elements over said antenna operating BW.

28. A method as in claim 24, wherein forming said dual delta loop elements comprises forming shapes on a desired surface where said dual delta loop elements are formed from a conductive metal foil or formed by a conductive spray coating based on said determined dimensions and structure, wherein said first and second dual delta loop elements are each masked on a different side of a relatively thin non-conductive structure.

29. A method as in claim 24, wherein forming said dual delta loop elements comprises forming dual delta loop elements from conductive metal.
